(19) United States
(12) Patent Application Publication
(10) Pub. No.: US 2006/0095272 A1
(43) Pub. Date: May 4, 2006

(54) System for ordering, tracking and payment of goods and services

(76) Inventors: Matthew James Mulcahy, New South Wales (AU); Sebastian Mackinnon, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/528,231

(22) PCT Filed: Sep. 18, 2003
(86) PCT No.: PCT/AU03/01223

§ 371 Date: Aug. 15, 2005

(30) Foreign Application Priority Data
Sep. 18, 2002 (AU) 2002951617
Mar. 12, 2003 (AU) 2003200960

(51) Int. Cl. G06Q 99/00; H04L 9/00; H04K 1/00

(52) U.S. Cl. 705/1; 705/80

(57) ABSTRACT

A management interface hub mediating between a procurer of goods or services and providers of goods or services, wherein communication between said interface hub and said providers is via any one of a selection of communication methods.

The present invention relates to intermediate systems for the management of commercial transactions between any one of a group of consumers and an extensive group of providers offering substantially similar goods or services and where such transactions may be mediated by a plurality of communication channels.

### BACKGROUND

It is a feature of many industries that goods or services may be required from providers where those goods or services may be similar, but for a variety of reasons are required to be sourced from a large group of providers. In these situations the choice of provider is usually driven by considerations unrelated to the cost of the good or service.

Another feature often associated with such industries is that the ordering of the goods and services may be carried out by authorized third parties, possibly remotely located from that industry's center of operations.

A further complication in these environments is introduced by the varying modes of communication available to the interacting parties and the plethora of different formats of documents used.

The processes of ordering, tracking and payment for the goods or services may then become a major cost input as well as a source of inefficiency, time delays and loss of revenue.

It is an object of the present invention to provide a solution to some of these disadvantages.

### BRIEF DESCRIPTION OF INVENTION

Accordingly, in one broad form of the invention there is provided a management interface hub mediating between a procurer of goods or services and providers of goods or services, wherein communication between said interface hub and said providers is via any one of a selection of communication methods.

Preferably all records relevant to the procurement of said goods or services are maintained on said interface hub databases.

Preferably said interface hub mediates between a plurality of procurers of goods or services, each one of said plurality of procurers obtaining goods or services from a set of providers offering similar product.

Preferably the choice of said providers is dictated by criteria other than price.

Preferably said communication methods between said providers and said interface hub may include:
(a) e-mail over the internet
(b) facsimile transmissions
(c) postal mail services
(d) internet pages
(e) telephone
(f) data connection

Preferably communication between said procurer of said goods or services and said interface hub is via an internet web site.

Preferably said communication between said procurer and said interface hub includes the transfer to said interface hub of orders for goods or services, said orders specifying a selected one of said providers.

Preferably said communication between said procurer and said interface hub includes the transfer to said interface hub of orders for goods or services, said orders specifying criteria for the selection of a selected one of said providers.

Preferably said communication between said interface hub and said procurer includes the transfer of data received from said providers, said data processed and formatted by said interface hub to conform to the requirements of said procurer, said data further presented for access by said procurer in digital form.

Preferably said orders are initiated by said procurer.

Preferably said orders are initiated by authorized agents of said procurer.

Preferably said interface hub includes a document processing facility adapted to the extraction of data from paper documents for entry into digital databases.

Preferably said interface hub is adapted to process said providers to become registered providers to said procurer.

Preferably wherein registration permits access by said registered providers to specified areas of said databases maintained by said interface hub.

Preferably said goods or services are in the form of data.

Preferably said interface hub is adapted to initiate payments to said providers in return for goods or services presented to said interface hub.

Preferably said interface hub is adapted to pay variable amounts according to criteria associated with response from provider and wherein said criteria include:—
(a) speed of response
(b) length of response
(c) communication method

Preferably said database is provided with input protocols specific to said procurer and said providers.

Preferably said providers communicate with said interface hub via said internet web site.

Preferably said providers communicate with said interface hub via facsimile transmission.

Preferably said providers communicate with said interface hub via postal mail service.

Preferably said providers are paid for goods or services provided on presentation of invoice.

Preferably said hub is adapted to the collation of statistical data relating to the interactions between said hub, said procurers and said providers, said data providing for quality control, prevention of fraud and industry benchmarking of said interactions.

Accordingly, in another broad form of the invention there is provided an intermediary procurement management hub adapted to the ordering, collection and preparation of formatted and homogenized data relevant to transactions between at least one procurer and one of a set of providers, wherein said providers are linked by a commonality of service offered to said one procurer.

Preferably said commonality of service is that provided by General Practitioners and Specialists, and wherein said data includes Private Medical Attendant's Records requested by said procurer via said hub.

Preferably said commonality of service is that provided by repair services to insurance companies, and wherein said data includes records relating to services requested by said procurer via said hub.

Preferably said commonality of service is that provided by paramedical and pathology services.

Preferably said commonality of service is that provided by repair services to insurance companies.

Preferably said commonality of service is related to the provision of references in support of applications for employment made to said procurer.

Preferably said commonality of service is related to the provision of labour to said procurer.

Preferably said data includes time sheet and time verification data requested by said procurer.

Preferably said data includes documentary verification data requested by said procurer.

Preferably the transfer of data between said procurer and said management hub is by means of an internet web site.

Preferably said the transfer of data between said providers and said management hub is by means of an e-mail.

Preferably said transfer of data between said providers and said management hub is by means of facsimile transmissions.

Preferably said transfer of data between said providers and said management hub is by means of a postal service.

Preferably said transfer of data between said providers and said management hub is by means of a telephone service.

Preferably wherein said hub is adapted to the collation of statistical data relating to the interactions between said hub, said procurers and said providers, said data providing for quality control, prevention of fraud and industry benchmarking of said interactions.

Accordingly, in yet another broad form of the invention a method for the procurement of goods or services required by a procurer from one of a set of providers linked to said procurer by a commonality of goods or services wherein said goods and services are in the form of data, through the use of a management interface hub, said method including the steps of:
(a) said procurer placing an order for goods or services on said management interface hub by means of data entry via an internet web site maintained by said management interface hub,
(b) said order specifying one or more providers or criteria for the selection of said goods or services,
(c) said management interface hub establishing a first method of communication with said one of said set of providers,
(d) said management interface hub arranging registration of said one of said set of providers, said registration conferring access by said one of said set of providers to said management interface hub databases,
(e) said one of said set of providers returning data to said management interface hub through a second method of communication.

Preferably said first or second method of communication includes the methods of:
(a) data entry through an internet web site
(b) facsimile transmissions
(c) postal service mail
(d) telephone
(e) data connection

Preferably said management interface hub processes data received from providers into a homogenized digital data set formatted according to the requirements of said procurer.

Preferably data received from said one of said set of providers through facsimile or postal service mail is processed for data extraction through character recognition (OCR) software.

Preferably said management interface hub collates orders from a number of said procurers for goods or services required from a one of said providers, said hub alerting said provider to said orders by means of a list displayed on:
(a) an internet web page;
(b) a facsimile transmission;
(c) a notification by post;
(d) a data connection transmission;

Accordingly, in yet another broad form of the invention there is provided a management interface hub mediating between a plurality of procurers of goods or services and any one of a plurality of providers of goods or services, wherein said interface hub is adapted to direct requests for supply of said goods and services to appropriate ones of said plurality of providers.

Preferably communication between said hub and said providers of goods and services is via any one of a selection of communication methods.

Preferably all records relevant to the supply of said goods or services are maintained on interface hub databases.

Preferably the choice of said providers is dictated by criteria other than price.

Preferably said communication methods between said providers and said interface hub may include:
(a) e-mail over the internet
(b) facsimile transmissions
(c) postal mail services
(d) internet pages
(e) telephone
(f) data connection

Preferably communication between said procurers of said goods and services and said interface hub is via an internet web site.

Preferably said communication between said procurers and said interface hub includes the transfer to said interface hub of orders for goods or services, said orders specifying criteria for the selection of a selected one of said providers.

Preferably said communication between said interface hub and said procurers includes the transfer of data received from said providers, said data processed and formatted by said interface hub to conform to the requirements of said procurers, said data further presented for access by said procurers in digital form.

Preferably said interface hub includes a document processing facility adapted to the extraction of data from paper documents for entry into digital databases.

Preferably said interface hub is adapted to process said providers to become registered providers to said procurer.

Preferably registration permits access by said registered providers to specified areas of said databases maintained by said interface hub.

Preferably said interface hub is adapted to initiate payments to said providers in return for the presentation of data to said interface hub confirming supply of goods or services.

Preferably said interface hub is adapted to pay variable amounts according to criteria associated with response from provider and wherein said criteria include:
(a) speed of response
(b) length of response
(c) communication method

Preferably said database is provided with input protocols specific to said procurers and said providers.

Preferably said providers communicate with said interface hub via said internet web site.

Preferably said providers communicate with said interface hub via facsimile transmission.

Preferably said providers communicate with said interface hub via postal mail service.

Preferably said hub is adapted to the collation of statistical data relating to the interactions between said hub, said procurers and said providers, said data providing for quality control, prevention of fraud and industry benchmarking of said interactions.

Accordingly, in yet another broad form of the invention there is provided an interface hub of any preceding claim wherein data and/or documents pertaining to compliance with current taxation provisions relevant to the commercial transactions between said service providers and said service procurers is captured for inclusion in said hub databases.

### BRIEF DESCRIPTION OF THE DRAWINGS

Embodiments of the present invention will now be described with reference to the accompanying drawings wherein:

FIG. 1 is a schematic representation of a management interface hub according to a first preferred embodiment of the invention.

FIG. 2 is an operational flow chart of the management interface hub of FIG. 1.

FIG. 3 is an operational flow chart of a management interface hub according to a second preferred embodiment.

FIG. 4 is an operational flow chart of a management interface hub according to a third preferred embodiment.

FIG. 5 is an operational flow chart of yet a further preferred embodiment of a management interface hub according to the invention.

FIG. 6 is a display screen for data entry and information for interaction with a management hub according to the invention.

### DETAILED DESCRIPTION OF PREFERRED EMBODIMENTS

It is a feature of at least some embodiments of the present invention that it facilitates commercial interaction between a set of numerous providers providing a similar product or service to a particular corporate entity. This is achieved firstly by providing an intermediary acting on behalf of a participating corporate entity in processing its requests for goods or services and secondly, by providing all relevant documentation and data required by the particular entity relative to the acquisition of a good or service in a homogenized, digital format tailored to the needs of the entity. The intermediary may be regarded as a processing interface hub and may act on behalf of a number of corporate entities and their sets of related goods or services providers.

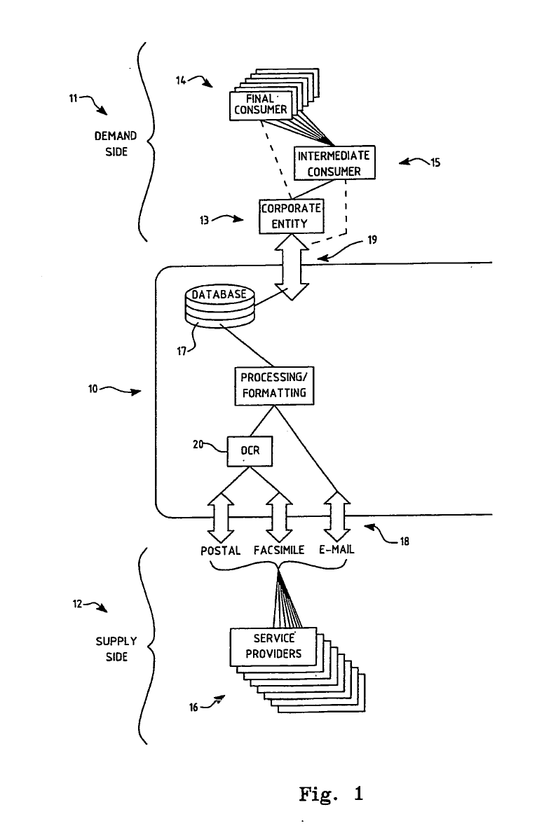

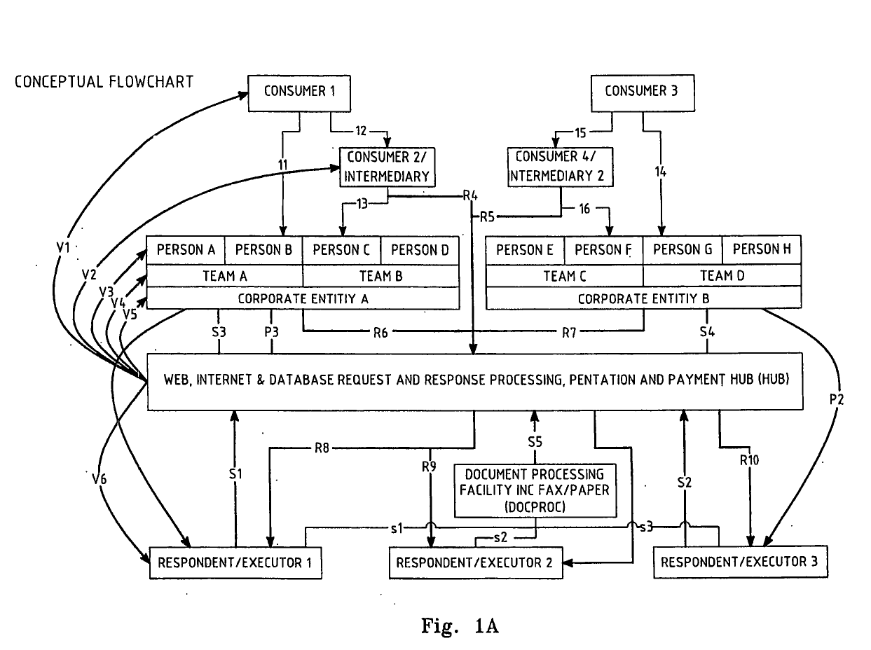

In a first preferred embodiment of the present invention with initial reference to FIG. 1 a management interface hub 10 for ordering, tracking and payment of goods and services includes centralised processing, data storage and communication facilities adapted to interact with a demand side 11 and a supply side 12.

In this first embodiment (adapted to the requirements of the life insurance industry), the demand side 11 includes a level of corporate entities 13 and two consumer levels; a final consumer level 14 and an intermediate consumer level 15. The supply side is comprised of a number of providers of those particular goods or services applicable to the activities of the corporate level entities.

The interface hub 10 is an independent “arm's length” processing center which includes databases 17, multiple communication interface facilities 18, data input and output means 19 and a document processing facility 20 comprising a scanning and character recognition (OCR) system. Databases and communication interfaces are structured to suit the requirements of individual corporate level entities and include access and visibility of data protocols as specified by the corporate entity. The database for a particular corporate level entity will include particulars of registered service providers, billing procedures, formats for data to be supplied to the corporate entity and the like. Data input from the corporate entity and data output to the corporate entity is through an internet web site maintained by the interface hub.

In this first preferred embodiment, the final consumer level 14 may in this example comprise applicants for life insurance products from one of a number of insurance companies of the corporate level 13. Applications could be made directly by the applicants to these companies, but may more frequently be made through the intermediate level 15 which may include for example, financial planners and insurance brokers. The provider level 12 will be comprised of General Practitioners and perhaps Specialists.

Because the corporate entity, in this example an insurance company, may receive applications from a very extensive geographical area, the number of providers is potentially very large. The database will carry information and communication details for a large number of practitioners but there will be a recurring need to add new providers to the database.

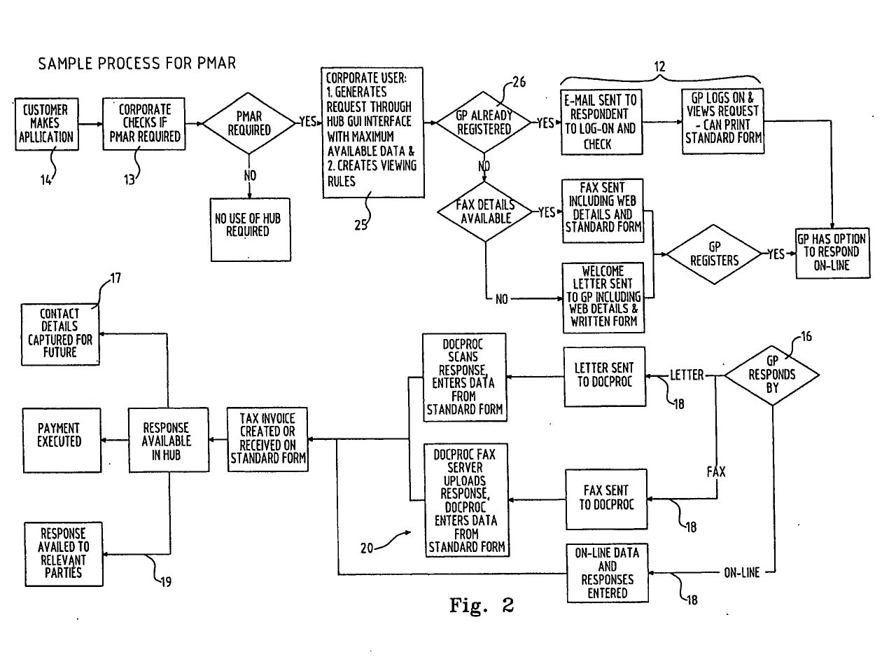

In this example with reference to FIG. 2, the corporate level entity when in receipt of an application assesses what, if any, medical information may be required and, if a test or tests are required, generates a request with all available relevant data for processing and execution by the interface hub. This is conveyed to the interface hub via the internet by means of a standard template specific to the requesting corporate entity. The data will include the personal details of the applicant and the service or services to be provided with details of specific medical enquiries and the subsequent furnishing of a Private Medical Attendant's Report (PMAR). It may furthermore specify a preferred General Practitioner or Specialist, often in accordance with the preference or the geographic location of the applicant. In this respect the choice of a provider is independent of price and providers are not in any sense competitors.

Other details provided with the request for supply of service may specify the intermediate consumer who mediated the initial application and what if any level of access he or she may be granted to the database information relevant to the applicant. Some specific data access may also be granted to the applicant.

Again with reference to FIG. 2, the interface hub now proceeds to the processing of the received request. It firstly checks if the specified service provider is already registered in the database for the corporate entity.

If not, the interface hub will open a communication channel with the provider, if possible by e-mail, otherwise by facsimile or surface mail. Initial communication with the provider will include an invitation to register as a provider and a Personal Identification Number (PIN) for use once registered. It will also include an authorization to supply the service requested by the corporate entity, details of the interface hub operation, options for communication with the interface hub and pro-formas for billing and the data to be supplied.

The provider may respond by any one of the optional methods; e-mail, facsimile or mail. The relevant data of the provider and the means of communication to be used for future interactions will be captured from the response for entry into the database. Data may be captured directly if the response is in the preferred electronic form from data field entry by the provider over the internet. In the case of facsimile or mail, data will be captured as far as possible by means of the Document Processing Facility, augmented as required by manual input or image capture.

Preferred communication is on-line through the interface hub's internet web site. The site allows a registered provider access to the provider's relevant section of the database enabling viewing of current and pending requests for supply of services, up-to-date financial records of transactions, formatted pages for data entry, invoicing, and other provider and corporate entity specific purposes.

On receipt of data from the provider, the interface hub will check for conformance with the request and arrange for payment to the provider.

Independent of the communication means adopted by the provider, the data provided is forwarded to the requesting corporate entity in the format specified by it. This allows for the direct incorporation of the data into the corporate entity's own database and, as for example in the case of an insurance company, the completion of the underwriting process.

In a second preferred embodiment of the invention, the interface hub is again directed to the needs of the insurance industry. In this instance the need is for the provision of paramedical or pathology services. The request for paramedic or pathology services in this instance will normally originate from the intermediate consumer level although it may also be by direction from the insurance company.

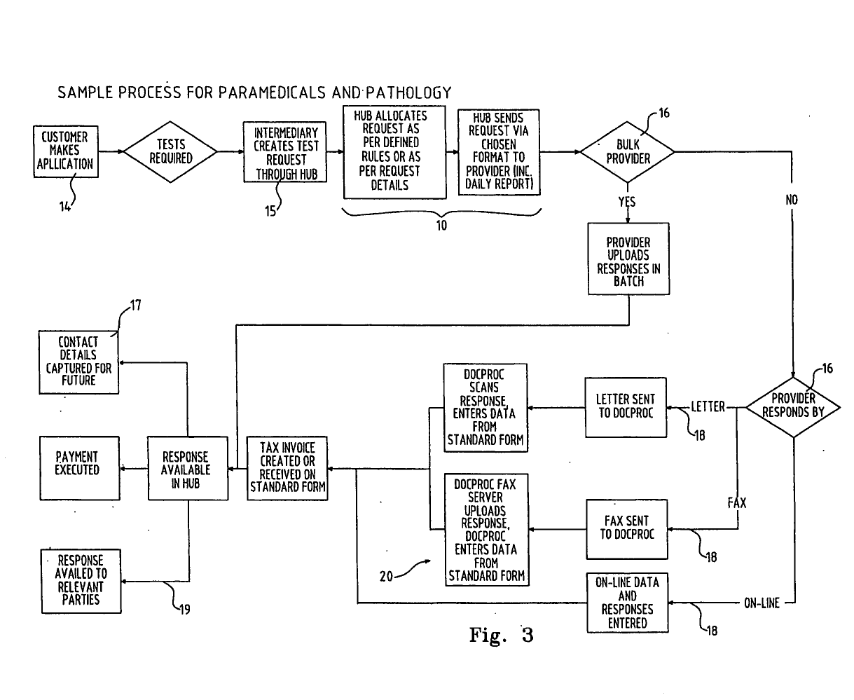

In this embodiment the group of providers will be considerably more restricted in number and at least some, for example pathology labs, may generate considerable numbers of reports. These providers, as shown in FIG. 3 will be registered with the interface hub as bulk providers. Although not shown in FIG. 3, any provider not previously registered may be invited to do so in a similar way to that described in the first embodiment above.

Bulk providers will be structured to provide their data electronically and in an agreed format. This allows for automatic processing by the interface hub for presentation of the data to those parties authorized to receive it, and for payment to the provider.

Where service is received from a non-bulk provider, the data will again be processed according to the form in which it is received. Facsimile and mail documents will be processed by the document processing facility for data capture and entry into the database, the data formatted as specified by the corporate entity and payment effected. Data provided on-line may be processed automatically as for bulk providers subject to a separate operation of invoice preparation.

In a further embodiment of the invention the processing interface hub is adapted to the needs of personnel recruitment by corporate level entities. Especially in situations where a large number of personnel is required for a particular project and/or a large number of applications of apparently similar quality is received for an available vacancy, the time required for the follow up of referees can place a considerable burden on the resources of the recruiting company or employment agency.

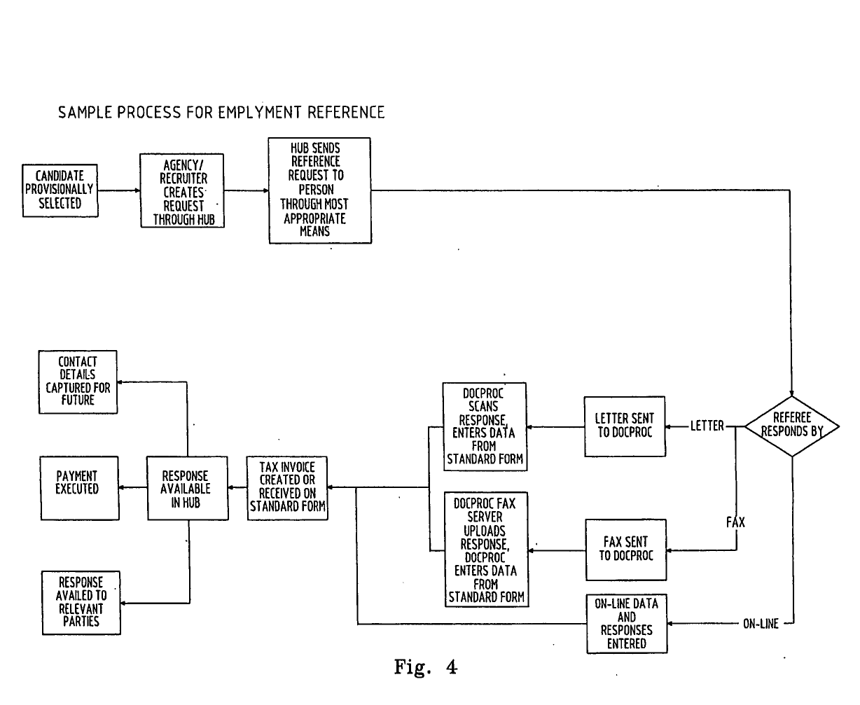

In this embodiment the recruiting company or agency as shown in FIG. 4 makes a provisional selection of applicants and passes their details to the interface hub for processing. The interface hub proceeds to contact and establish a communication channel with the referees, seeking where possible to solicit-responses electronically according to a prepared questionnaire and offering incentives where authorized. Those able and willing to use the interface hub web site for their response are assigned a PIN to allow access. Where electronic communication over the interface hub's internet web site is not possible or refused, responses received by facsimile or mail from referees will be processed by the document processing facility.

Responses are formatted and made available to the recruiting company or agency by the interface hub and, where required, incentive payments effected.

In yet a further embodiment of the invention the interface hub is directed at casual, temporary or contract staff management. By way of non-limiting example, the modern workforce increasingly includes personnel who may work at remote locations, in irregular patterns or for short periods of employment. In many cases these people will rarely if ever present at a central office and have no organizational or e-mail address. Management of this type of workforce may be based on time sheet records signed by a supervising officer of the employing company or in some instances by a customer of the company.

In one form of this embodiment the corporate entity itself may be the consumer of services provided by the casual, contract or temporary employee. In another form the corporate entity may constitute an intermediate consumer, acting as an agency providing services from a pool of providers to final consumers.

In both forms requests for the provision of services are passed to the interface hub which will have in its database any contractual details existing, or to be applied, between the corporate entity and the service provider, communication channel details as well as methods of payment for service, methods of time keeping and justification and the like. The interface hub will arrange to establish these details for any new provider to the corporate entity as required.

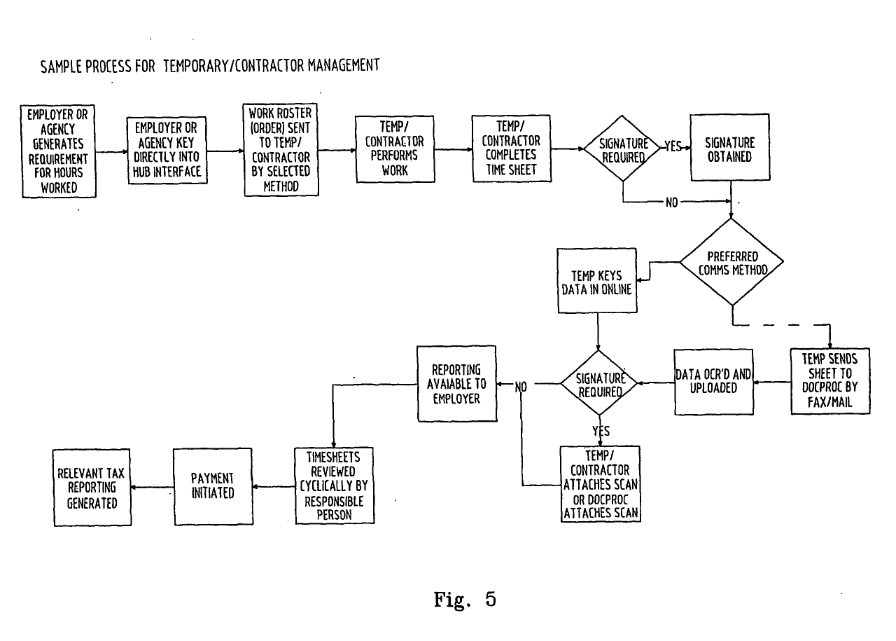

FIG. 5 illustrates a typical operational process for this embodiment. The interface hub receives a work request or roster for a particular provider and creates a requirement record. This record is sent to the provider or in appropriate cases to his or her supervisor. Again the preferred means of communication and the provision of time sheet records by the provider or supervisor to the interface hub is on-line by way of the interface hub's web site. On-line returns of time sheet details may need to be accompanied by a scanned copy where a supervisor's or other confirmatory signature is required. Documents received by facsimile or mail are processed by the document processing facility. Interface hub staff may review time sheets on a regular basis if required by the corporate entity, payments made to the providers and taxation records prepared. All relevant data is formatted and homogenized in accordance with the corporate entity's preferences and made available to it from the interface hub database.

It will be clear that in a further form of the system the interface hub may provide a mediating facility between a single goods or services provider and a multiplicity of corporate entities or procurers.

Thus by way of a first example, a particular General Practitioner, when logging in via the internet to the interface hub, may be alerted to the need to provide Private Medical Attendant's Reports to a number of different insurance companies. In a further example, a backpacker may register with the hub as available for casual work. By logging into the hub via the internet he or she may be provided with a schedule of jobs available over a period of time from different employers of casual labour to which the backpacker is invited to respond.

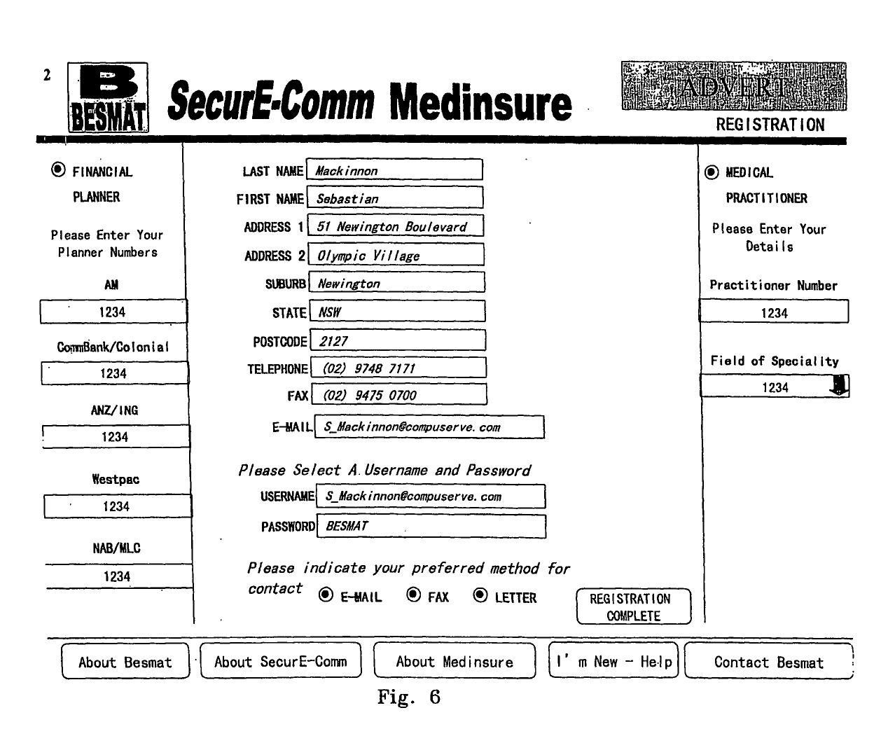

In yet further embodiments of the present system as illustrated in FIG. 6, the interface hub is adapted to the capture of the Australian-Business Number (ABN) and/or Tax File Number (TFN) of a provider, thus allowing for the on-line generation of a tax invoice, avoiding any withholding tax and allowing the claiming of tax input credits where these are applicable.

In yet further embodiments of the present system the interface hub databases are adapted to statistical analysis of the data gathered from the interaction of both the supply and demand sides with the hub. This facility allows a procurer or corporate entity to exercise quality control, guard against fraud and perform cost/benefit analysis of its procurement activities.

The above describes only some embodiments of the present invention and modifications, obvious to those skilled in the art, can be made thereto without departing from the scope and spirit of the invention.

1. A management interface hub mediating between a procurer of goods or services and providers of goods or services, wherein communication between said interface hub and said providers is via any one of a selection of communication methods.

2. The interface hub of claim 1 wherein all records relevant to the procurement of said goods or services are maintained on said interface hub databases.

3. The interface hub of claim 1 wherein said interface hub mediates between a plurality of procurers of goods or services, each one of said plurality of procurers obtaining goods or services from a set of providers offering similar product.

4. The interface hub of claim 1 wherein the choice of said providers is dictated by criteria other than price.

5. The interface hub of claim 1 wherein said communication methods between said providers and said interface hub may include:
(a) e-mail over the internet
(b) facsimile transmissions
(c) postal mail services
(d) internet pages
(e) telephone
(f) data connection

6. The interface hub of claim 1 wherein communication between said procurer of said goods or services and said interface hub is via an internet web site.

7. The interface hub of claim 6 wherein said communication between said procurer and said interface hub includes the transfer to said interface hub of orders for goods or services, said orders specifying a selected one of said providers.

8. The interface hub of claim 6 wherein said communication between said procurer and said interface hub includes the transfer to said interface hub of orders for goods or services, said orders specifying criteria for the selection of a selected one of said providers.

9. The interface hub of claim 1 wherein said communication between said interface hub and said procurer includes the transfer of data received from said providers, said data processed and formatted by said interface hub to conform to the requirements of said procurer, said data further presented for access by said procurer in digital form.

10. The interface hub of claim 9 wherein said orders are initiated by said procurer.

11. The interface hub of claim 9 wherein said orders are initiated by authorized agents of said procurer.

12. The interface hub of claim 1 wherein said interface hub includes a document processing facility adapted to the extraction of data from paper documents for entry into digital databases.

13. The interface hub of claim 12 wherein said interface hub is adapted to process said providers to become registered providers to said procurer.

14. The interface hub of claim 13 wherein registration permits access by said registered providers to specified areas of said databases maintained by said interface hub.

15. The interface hub of claim 1 said goods or services are in the form of data.

16. The interface hub of claim 15 wherein said interface hub is adapted to initiate payments to said providers in return for goods or services presented to said interface hub.

17. The interface hub of claim 15 wherein said interface hub is adapted to pay variable amounts according to criteria associated with response from provider and wherein said criteria include:—
(a) speed of response
(b) length of response
(c) communication method

18. The interface hub of claim 17 wherein said database is provided with input protocols specific to said procurer and said providers.

19. The interface hub of claim 1 wherein said providers communicate with said interface hub via said internet web site.

20. The interface hub of claim 1 wherein said providers communicate with said interface hub via facsimile transmission.

21. The interface hub of claim 1 wherein said providers communicate with said interface hub via postal mail service.

22. The interface hub of claim 1 wherein said providers are paid for goods or services provided on presentation of invoice.

23. The management interface hub claim 1 to 22 wherein said hub is adapted to the collation of statistical data relating to the interactions between said hub, said procurers and said providers, said data providing for quality control, prevention of fraud and industry benchmarking of said interactions.

24. An intermediary procurement management hub adapted to the ordering, collection and preparation of formatted and homogenized data relevant to transactions between at least one procurer and one of a set of providers, wherein said providers are linked by a commonality of service offered to said one procurer.

25. The management hub of claim 24 wherein said commonality of service is that provided by General Practitioners and Specialists, and wherein said data includes Private Medical Attendant's Records requested by said procurer via said hub.

26. The management hub of claim 24 wherein said commonality of service is that provided by repair services to insurance companies, and wherein said data includes records relating to services requested by said procurer via said hub.

27. The management hub of claim 24 wherein said commonality of service is that provided by paramedical and pathology services.

28. The management hub of claim 24 wherein said commonality of service is that provided by repair services to insurance companies.

29. The management hub of claim 24 wherein said commonality of service is related to the provision of references in support of applications for employment made to said procurer.

30. The management hub of claim 24 wherein said commonality of service is related to the provision of labour to said procurer.

31-62. (canceled)
